(19) United States
(12) Patent Application Publication
(10) Pub. No.: US 2006/0193707 A1
(43) Pub. Date: Aug. 31, 2006

(54) Machine tool

(76) Inventors: Hideo Nakajima, Osaka (JP); Hiroshi Yonetani, Nara (JP)

Correspondence Address: JUDGE & MURAKAMI IP ASSOCIATES, DOJIMIA BUILDING, 7TH FLOOR, 6-8 NISHITEMMA 2-CHOME, KITA-KU, OSAKA-SHI, 530-0047, JP

(21) Appl. No.: 10/543,991

(22) PCT Filed: Jan. 23, 2004
(86) PCT No.: PCT/JP04/00632

§ 371 Date: Jul. 29, 2005

(30) Foreign Application Priority Data
Jan. 31, 2003 (JP) 2003-023887

(51) Int. Cl. B23D 7/00; B22D 27/04

(52) U.S. Cl. 409/235; 164/122.1

(57) ABSTRACT

The present invention relates to a machine tool including a moving parts that move in predetermined directions, wherein the moving parts are made of metal obtained by gradually cooling and solidifying along a predetermined orientation melted metal in which gas atoms have been dissolved, wherein numerous slender voids extending along the predetermined orientation are formed by precipitating the gas atoms through a decrease in the dissolved amount of gas atoms accompanying a decrease in the temperature of the metal; accordingly, the moving member is constituted of so-called porous metal. The machine tool thus not only has lightened moving parts, it also has excellent vibration damping and thermal properties, making it suitable for high speed machining.

### TECHNICAL FIELD

The present invention relates to machine tools equipped with moving parts that move in predetermined directions.

### BACKGROUND ART

One example of machine tools is the machining center, which is made up of a variety of structures including a bed, a column, a spindle head, a spindle, a saddle, and a table; another example is the NC lathe, which is made of a variety of structures including a bed, a headstock, a spindle, a saddle, a tool rest, and a tailstock.

Suitable rigidity and vibration damping are required of these machine tool structures, and in order to meet these requirements while taking into consideration machinability and cost in manufacturing the machine tool structures, cast iron or steel has generally been used up to now.

Meanwhile, with enhanced machining efficiency being a must, in recent years a drive to accelerate machine-tool operations has been underway; thus the lightening of, among the machine tool structures, the moving parts—including the column, the spindle head, the saddle, the table, and the tool rest—which are moved along appropriate feed axes, is being sought, as would follow from demands for such acceleration of machine-tool operations, and attempts have been made to put materials such as aluminum alloys and ceramics to use in such moving parts.

However, because the coefficient of linear expansion of aluminum alloys is about twice that of cast iron or steel, a problem with aluminum alloys is that they tend to deform under heat; likewise, a problem with ceramics is that they are costly.

An object of the present invention, brought about in view of the circumstances discussed above, is to make available machine tools having lightened moving parts, and that exhibit superior performance in terms of characteristics including vibration damping and thermal properties.

### DISCLOSURE OF INVENTION

The present invention involves a machine tool provided with moving parts that move in predetermined directions, wherein the moving parts are made of metal obtained by gradually cooling and solidifying along a predetermined orientation molten metal in which gas atoms have been dissolved, wherein numerous slender voids extending along the predetermined orientation are formed by precipitating the gas atoms through a decrease in the dissolved amount of gas atoms accompanying a decrease in the temperature of the metal.

In the above manner, the moving parts according to the present invention are made of metal in which by gradually cooling and solidifying along a predetermined orientation molten metal in which gas atoms have been dissolved, the gas atoms precipitate during that solidification process and numerous slender voids extending along the predetermined orientation are formed; that is, the moving parts are formed of so-called porous metal.

Generally, the amount of gas atoms which dissolve in molten metal depends upon the pressure of the gas, and while a large amount of gas atoms will dissolve if the pressure is high, only a small amount will dissolve if the pressure is low. In porous metal, by controlling the cooling and the solidification state of molten metal in which gas atoms are dissolved under a predetermined pressure based upon this characteristic, that is, by gradually cooling from a predetermined orientation and solidifying the molten metal, numerous slender voids extending along that orientation are formed due to the gas molecules which precipitated during the solidification process.

Conventionally, irregularly formed voids in the metal were regarded as flaws that reduce the strength of the metal, but by regularly forming the voids such that the voids run lengthwise in a predetermined orientation, the crystal structure of the metal is formed so that it runs in that orientation, lending strength along the orientation in which the voids form, and making it possible to reduce the weight of the parts in comparison to a solid body with the same external dimensions.

Because this porous metal is characterized by a larger amount of internal friction due to the voids than in a solid body, vibrations can be effectively suppressed, and this metal further has the quality of being able to effectively release heat of the porous metal via the voids.

There are two types of porous metal, porous metal in which the voids are formed in a single orientation, and porous metal in which the voids are formed radially. The former can be produced by a molten-metal cooling process in which the cooling is directed from one side towards the opposite side, and the latter can be produced by a molten-metal cooling process in which the cooling is directed from the periphery of the metal towards the center.

In this way, in accordance with the present invention, by making the moving parts of the machine tool from porous metal, the weight of the moving parts is reduced, for example improving responsiveness to NC command. It also becomes possible to suppress chatter vibration due to a vibration suppression effect as well as to suppress thermal displacement due to a heat exhaust effect, and thereby, it is possible to greatly improve machining accuracy. Also, by lightening the moving parts, along with being able to move the moving parts at high speed, it is possible to reduce the power load necessary for movement, making it possible to decrease power consumption.

In the case of a machining center, examples of moving parts include columns, spindle heads, saddles and tables, and in the case of an NC lathe, examples of moving parts include saddles and tool rests.

In such instances, the moving parts are ordinarily assembled by joining their component parts by screwing or welding. When joining the component parts together by welding, the vicinity of the welded part tends to acquire a hard and brittle mechanical properties due to quenching effect, and flaws such as cracks in the welded part tend to easily occur, in proportion to the amount of carbon included in the metal. Therefore, it is preferable for the metal to be low-carbon steel which includes only a small amount of carbon.

When the metal is low-carbon steel, it is preferable to include in the gas atoms at least nitrogen atoms. By doing so, when the aforementioned voids are formed, atoms constituting the low-carbon steel, such as aluminum, chromium, and titanium atoms, react with nitrogen atoms on the metal surface of the voids, forming a nitride, and the effect is obtained that the metal surface can be hardened by this nitride. Although there are voids in the nitrided porous metal, its strength in the direction parallel to the voids is equivalent to that of a solid body with the same external dimensions.

From the following detailed description in conjunction with the accompanying drawings, the foregoing and other objects, features, aspects and advantages of the present invention will become readily apparent to those skilled in the art.

### BRIEF DESCRIPTION OF DRAWINGS

FIG. 1 is an oblique view diagramming the configurational outline of a preferable machine tool involving the present invention;

FIG. 2 and FIG. 3 are cross-sectional views diagramming the configurational outline of apparatuses for manufacturing porous metal; and

FIG. 4 and FIG. 5 are explanatory diagrams for explaining the internal structure of porous metal.

### MODES FOR CARRYING OUT THE INVENTION

Below, in order to describe the present invention in further detail, it will be explained based on the accompanying drawings.

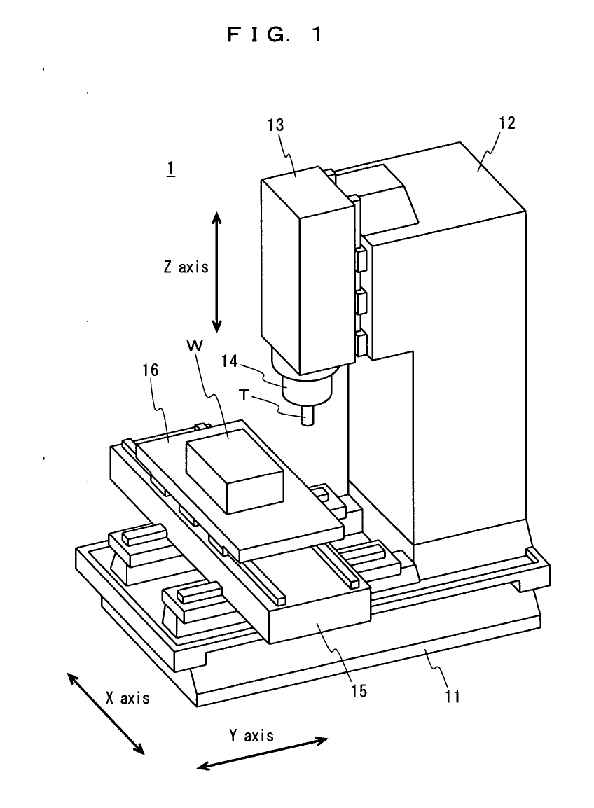

As shown in FIG. 1, a machine tool 1 of the present embodiment is a machine tool of the type called a vertical machining center, and comprises: a bed 11; a column 12 disposed upon the bed 11; a spindle head 13 which is movable in the Z axis direction and supported by the column 12; a spindle 14 supported by the spindle head 13 such that the spindle 14 may freely rotate; a saddle 15 disposed upon the bed 11 and movable in the Y axis direction orthogonal to the Z axis; and a table 16 disposed upon the saddle 15 and movable in the X axis direction orthogonal to both the Z axis and Y axis. A tool T is mounted to the spindle 14, and a workpiece W is placed on the table 16.

The machine tool 1 includes a Z axis feed mechanism (not shown) which moves the spindle head 13 in the Z axis direction, a Y axis feed mechanism (not shown) which moves the saddle 15 in the Y axis direction, an X axis feed mechanism (not shown) which moves the table 16 in the X axis direction, and a control apparatus (not shown) which, based on NC command controls the operation of respective drive motors for the Z axis feed mechanism (not shown), the Y axis feed mechanism (not shown), and the X axis feed mechanism (not shown). By moving the spindle head 13, the saddle 15, and the table 16 in their respective axial directions with the corresponding feed mechanisms (not shown), relative movement between the tool T and the workpiece W is achieved, and the workpiece W is machined.

Each component part of the spindle head 13, the saddle 15, and the table 16, which are moving parts, is made of so-called porous metal. That is, each part is made of metal obtained by gradually cooling metal in a molten state, in which gas atoms are dissolved, in a predetermined orientation until solidification. A decrease in the temperature of the metal is accompanied by a decrease in the amount of gas atoms dissolved, and due to precipitation of the gas atoms, numerous slender voids extending in the orientation of cooling are formed in the metal.

Generally, the amount of gas atoms which dissolve in molten metal depends on the gas pressure, and while a large amount of gas atoms will dissolve if the gas pressure is high, only a small amount will dissolve if the gas pressure is low. Porous metal is metal in which, by controlling the cooling and the solidification state of molten metal in which gas atoms are dissolved under a prescribed pressure based upon this characteristic, that is, by gradually cooling from a predetermined orientation and solidifying the molten metal, numerous slender voids extending along that orientation are formed in the metal due to the gas molecules that precipitated during the solidification process.

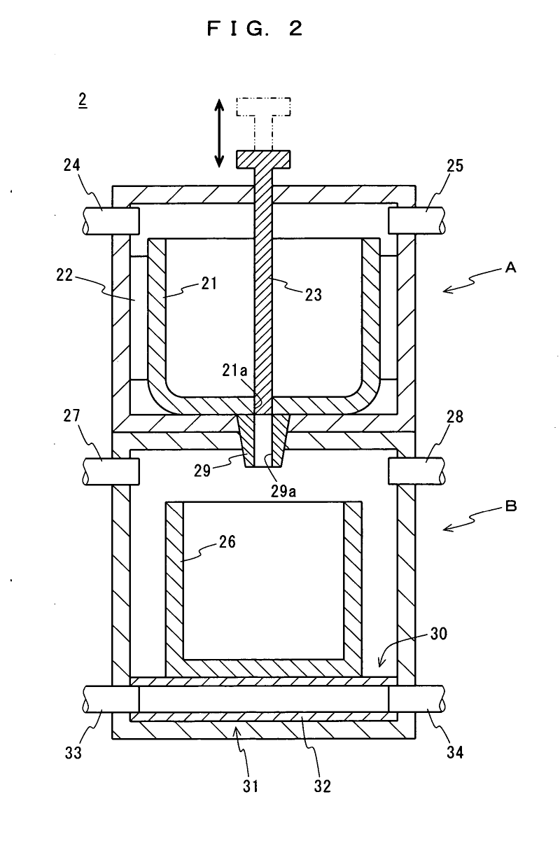

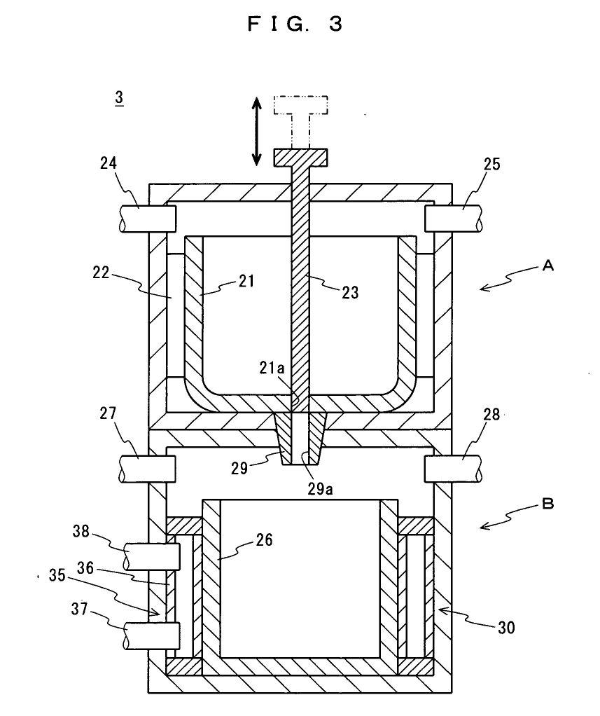

More specifically, porous metal can be manufactured using, for example, a manufacturing apparatus 2 as shown in FIG. 2 or a manufacturing apparatus 3 as shown in FIG. 3. As shown in FIG. 2 and FIG. 3, the manufacturing apparatuses 2 and 3 each have a heating chamber A and a solidification chamber B, respectively furnished with a closed space. The solidification chamber B is disposed below the heating chamber A, with which it is equalized by gas-drawing vacuum and gas-supplying pressurization. In FIG. 2 and FIG. 3, the same component parts are labeled with the same part numbers.

A crucible 21 in which a through-hole 21a is formed in the center part of the bottom wall, a heating apparatus 22 which heats the crucible 21, an occluding rod 23 whose upper end protrudes upward from the upper wall of the heating chamber A and whose lower end closes off the through-hole 21a, a gas draw tube 24 provided above the crucible 21, and a gas feed tube 25 are provided in the heating chamber A.

The occluding rod 23 is moved in the vertical direction by a raising-lowering device which is not shown in the drawings, and when it is in the lowest position, the lower end of the occluding rod 23 closes off the through-hole 21a. The gas draw tube 24 is connected to an evacuation apparatus not shown in the drawings, and the gas feed tube 25 is connected to a gas supply apparatus not shown in the drawings.

In the solidification chamber B are provided a mold 26, a cooling unit 31 as shown in FIG. 2 or a cooling unit 35 as shown in FIG. 3 of a cooling apparatus 30 which cools the mold 26, and pressure adjustment tubes 27 and 28 provided above the mold 26.

The cooling unit 31 is provided with a cooling member 32, which is hollow inside and disposed below the mold 26, and a water supply pipe 33 and a water drain pipe 34 respectively connected to the cooling member 32, and is configured so as to cool the bottom surface of the mold 26. On the other hand, the cooling unit 35 includes a cooling member 36, which is hollow inside and disposed around the periphery of the mold 26, and a water supply pipe 37 and a water drain pipe 38 respectively connected to the cooling member 36, and is configured so as to cool the periphery of the mold 26.

In both of the above-mentioned cooling members 32 and 36, cooling water from a cooling water circulation apparatus (not shown) of the cooling apparatus 30 is provided via the water supply pipes 33 and 37, and the provided cooling water is returned to the cooling water circulation apparatus (not shown) via the water drain pipe 34 and the water drain pipe 38 respectively. Also, the pressure adjustment tubes 27 and 28 are both connected to a pressure control apparatus not shown in the figures.

In the bottom wall of the heating chamber A and the top wall of the solidification chamber B, an introduction member 29 is disposed spanning these walls, and in this introduction member 29, the upper opening is in communication with the through-hole 21a of the crucible 21, and the lower opening opens above the mold 26, forming an introduction hole 29a.

According to the porous metal manufacturing apparatuses 2 and 3 configured in this way, at first, after solid low-carbon steel is suitably brought into the crucible 21, the gas within the heating chamber A is drawn out by the evacuation apparatus (not shown) via the gas draw tube 24 to bring the inside of the heating chamber A into a vacuum state. The pressure inside the solidification chamber B is adjusted to a predetermined pressure by the pressure adjustment apparatus (not shown) via the pressure adjustment tubes 27 and 28, and the mold 26 is cooled by cooling water supplied and circulated inside of the cooling members 32 and 36 by the cooling water circulation apparatus (not shown).

Next, the solid low-carbon steel within the crucible 21 is heated to a predetermined temperature by the heating apparatus 22, whereby the steel is melted into liquid form. Then, gas including nitrogen gas is supplied into the heating chamber A via the gas feed tube 25 by the gas supply apparatus (not shown) such that the pressure inside the heating chamber A becomes a predetermined pressure, and the supplied gas dissolves into the liquid low-carbon steel.

Next, when the occluding rod 23 is raised by the raising-lowering device (not shown), the low-carbon steel within the crucible 21 flows into the mold 26 through the through-hole 21a and the introduction hole 29a, and the low-carbon steel which has flowed in is cooled and solidified by the cooling apparatus 30.

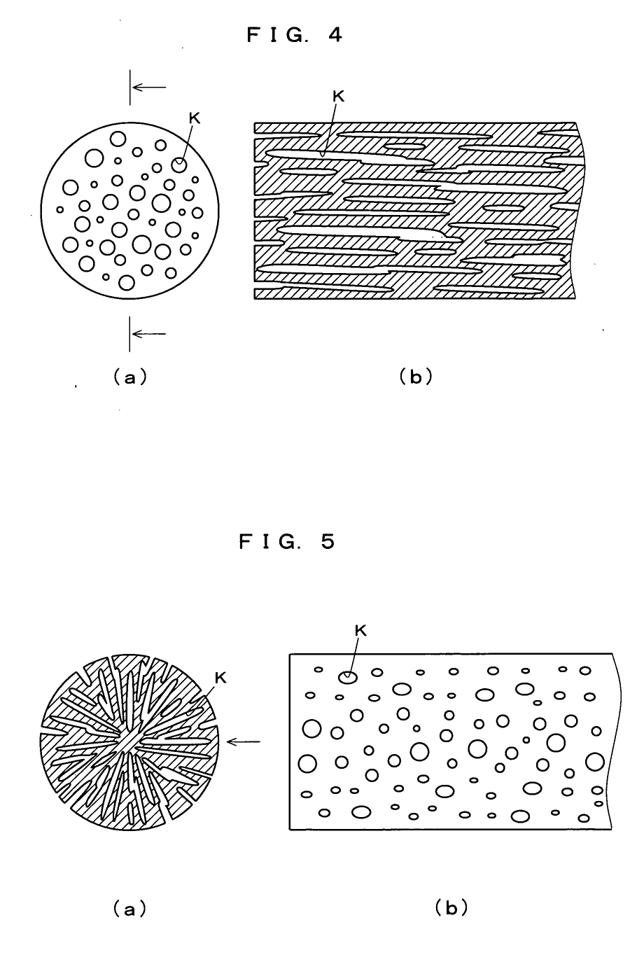

The process of cooling and solidifying the low-carbon steel which has flowed into the mold 26 differs between the manufacturing apparatus 2 shown in FIG. 2 and the manufacturing apparatus shown in FIG. 3. In the case of the manufacturing apparatus 2, because the cooling unit 31 is configured so as to cool the bottom surface of the mold 26, the low-carbon steel is gradually cooled and solidified from the bottom surface to the top of the mold 26, and therefore, as shown in FIG. 4, supersaturated gas precipitates such that numerous slender voids K extending in the vertical orientation of the mold 26 are formed. FIG. 4(a) is a plan view showing the porous metal, and FIG. 4(b) is a cross-sectional view of the porous metal.

On the other hand, in the case of the manufacturing apparatus 3, because the cooling unit 35 is configured so as to cool the periphery of the mold 26, the low-carbon steel is gradually cooled and solidified from the periphery of the mold 26 towards the center, and therefore, as shown in FIG. 5, supersaturated gas precipitates such that numerous slender voids K extending in a radial shape are formed. FIG. 5(a) is a cross-sectional view showing the porous metal, and FIG. 5(b) is a lateral view of the porous metal.

As shown in FIG. 4 and FIG. 5, voids K of various sizes are formed, and among these, mutually communicating voids are also formed.

Porous metal manufactured in the manner described above is appropriately used in the component parts of the spindle head 13, the saddle 15 and the table 16, which are moving parts, according to their attributes. That is, after the manufactured porous metal is appropriately machined into component parts with the desired shape, these are joined together by screwing or welding, and are variously assembled as the spindle head 13, the saddle 15, and the table 16.

In this respect, irregularly formed voids in low-carbon steel used as the raw material have conventionally been regarded as flaws that decrease the strength of the metal. However, by forming the voids regularly so that the voids run lengthwise along a predetermined orientation as described above, the crystal structure of the low-carbon steel forms so as to run in that orientation, lending strength in the orientation along which the voids form, and moreover, making it possible to reduce weight in comparison to a solid body with the same external dimensions.

Because this porous metal is characterized by a larger amount of internal friction due to the voids than in a solid body, vibrations can be effectively suppressed, and this metal further has the quality of being able to effectively release via the voids heat possessed by the porous metal.

In this way, in accordance with the machine tool 1 of the present invention, by making the moving parts of the machine tool 1, such as the spindle head 13, the saddle 15, and the table 16, of porous metal, the weight of the moving parts is reduced, improving, for example, responsiveness to NC command. It also becomes possible to suppress chatter vibration due to a vibration suppression effect as well as to suppress thermal displacement due to a heat exhaust effect, and thereby, it is possible to greatly improve machining accuracy. Also, by reducing the weight of the moving parts, along with being able to move the moving parts at high speed, it is possible to reduce the power load necessary for movement, making it possible to decrease power consumption.

Because the porous metal in the present embodiment is low-carbon steel, the amount of carbon included is small, and so even when the component parts of the moving parts are joined together by welding, flaws such as cracks in the welded portion are not likely to occur.

In the present embodiment, because gas including nitrogen gas is dissolved into the molten low-carbon steel, when the aforementioned voids K are formed, atoms constituting the low-carbon steel, such as aluminum, chromium, and titanium atoms, react with nitrogen atoms on the metal surface of the voids K, forming a nitride, obtaining the effect that the metal surface can be hardened by this nitride. Although the porous metal has voids K, its strength in the orientation parallel to the voids K is equivalent to that of a solid body with the same external dimensions.

The foregoing was a description of an embodiment of the present invention, but the specific embodiments that can be employed for the present invention are in no way limited to this.

For example, in the above embodiment, the porous metal constitutes the moving parts of a vertical machining center, but the invention is not limited to this; the above-described porous metal can constitute moving components of various machine tools, such as horizontal machining centers and NC lathes.

In the case of a horizontal machining center, examples of moving parts include columns, spindle heads, and tables, and in the case of an NC lathe, examples of moving parts include saddles and tool rests.

### INDUSTRIAL APPLICABILITY

As in the foregoing, a machine tool according to the present invention has lightened moving parts, and moreover excels in vibration damping and thermal properties, making the machine tool suitable for high speed machining operations.

1. A machine tool comprising moving parts that move in predetermined directions, said moving parts constituted from metal obtained by:
gradually cooling and solidifying along a predetermined orientation molten metal into which gas atoms have been dissolved;
decreasing, by an associated decrease in the temperature of the molten metal the amount of gas atoms dissolved in the molten metal, to precipitate out the gas atoms and form numerous slender voids, extending along the predetermined orientation, in the solidified metal.

2. A machine tool according to claim 1, wherein the metal is composed of low-carbon steel.

3. A machine tool according to claim 2, wherein the gas atoms include at least nitrogen atoms to form a nitride on the metal surface in the voids when the voids form.
the voids form.
